(19) United States
(12) Patent Application Publication
(10) Pub. No.: US 2013/0346537 A1
(43) Pub. Date: Dec. 26, 2013

(54) STORAGE OPTIMIZATION TECHNOLOGY

(71) Applicant: Critical Path, Inc., Dublin (IE)

(72) Inventors: Seamus Fitzpatrick, Co. Dublin (IE); Dermot Dunnion, Co. Dublin (IE); Donald Dew, Ajax (CA); Roger Allyn Wade, Wicklow (IE); Daniele Depetrini, Buccinasco (MI) (IT)

(21) Appl. No.: 13/920,394

(22) Filed: Jun. 18, 2013

Related U.S. Application Data
(60) Provisional application No. 61/661,096, filed on Jun. 18, 2012.

(51) Int. Cl. H04L 29/08

(52) U.S. Cl. CPC H04L 67/1097
USPC 709/213

(57) ABSTRACT

A rule-based system for utilizing available storage in combination with arbitrary transformations, such as compression or encryption, within an email system is disclosed herein. The system may include an event-based storage of messages in specific tiers of storage based on a subscriber's class-of-service, attributes of the message, or attributes of the attachments. An automated or administrator directed application of storage rules over an existing mailbox or set of mailboxes may also be implemented. A plurality of storage locations may be included in the system, and each may be associated with at least one of a type, protocol, or transformation to be applied.

### TECHNICAL FIELD

The present disclosure relates to messaging systems, in particular to the optimization of data storage in large scale messaging services.

### BACKGROUND

The use of smart mobile devices has increased dramatically in recent years. These devices, however, have limited local storage capacity. Messaging services (such as consumer email services), at the same time, may be expected to provide unlimited, reliable and secure storage. As a consequence, storage-related costs have become one of the most significant costs associated with a large messaging service. Thus, an increase in the effective capacity of existing storage, as well as a reduced cost and increased flexibility in the choice of storage mechanisms, offer competitive advances to the operators of any large messaging system.

### BRIEF DESCRIPTION OF THE DRAWINGS

FIG. 1A illustrates exemplary raw storage media costs.

FIG. 1B illustrates exemplary enterprise storage total cost of ownership trends.

FIG. 1C illustrates exemplary complete enterprise storage platform costs.

FIG. 1D illustrates exemplary cloud storage costs.

FIG. 1E illustrates exemplary smartphone, tablet, and PC & Laptop sales.

FIG. 2 illustrates an exemplary messaging system for the optimized storage of messages with respect to a plurality of storage locations.

FIG. 3 illustrates exemplary storage locations.

FIG. 4 illustrates an exemplary data flow of a rules engine storing received messages in storage locations according to tiering rules.

FIG. 5 illustrates an exemplary data flow of a rules engine storing received and scanned messages in storage locations according to tiering rules.

FIG. 6 illustrates an exemplary data flow of a storage interface retrieving stored messages.

FIG. 7 illustrates an exemplary process for storing received messages in storage locations according to tiering rules.

FIG. 8 illustrates an exemplary process for retrieving stored messages from storage locations.

### DETAILED DESCRIPTION

Described herein are methods, systems and techniques for optimizing storage usage in a messaging system, such as an email platform. In general, the system may distribute messages between different storage locations thus allowing for control and extensibility in the storage system. Each location may be associated with a different set of characteristics, which in combination with the characteristics of individual messages, can be evaluated against a set of rules to determine the preferred location. Such storage optimization capabilities may be transparent to subscribers of the messaging system.

Storage costs can be one of the key costs for large messaging applications. An increased use of smart mobile devices has created a demand for service based storage mechanisms (such as Internet message access protocol (IMAP)) while increasing message sizes (with mobile created content). Further, recent offerings from consumer email systems (e.g., the Gmail® service provided by Google, Inc. of Mountain View, Calif., the Hotmail® service provided by Microsoft, Inc. of Redmond, Wash., etc.) have resulted in increased and expanded storage quotas as an attractive differentiation.

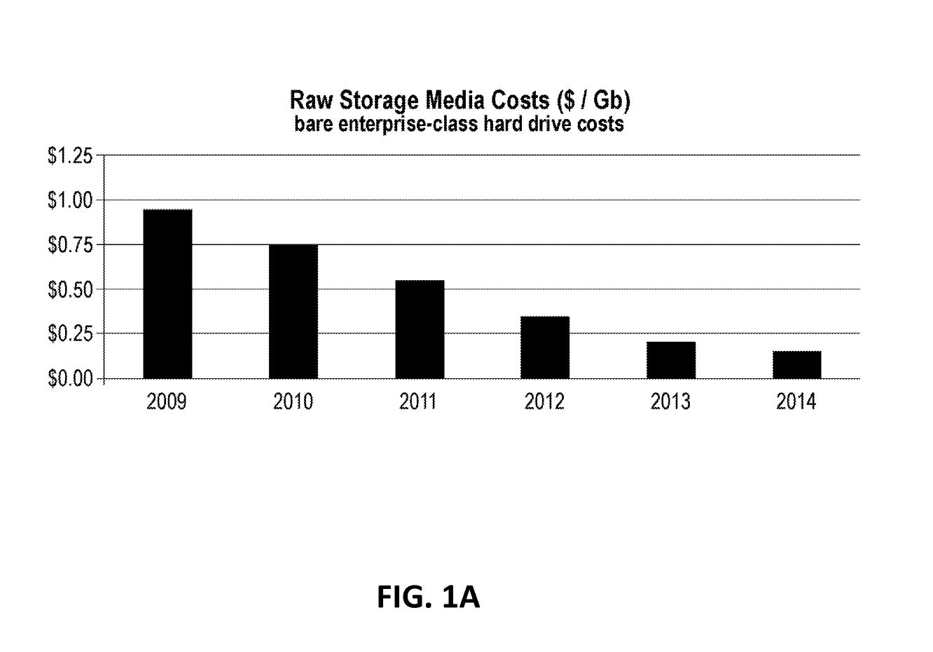

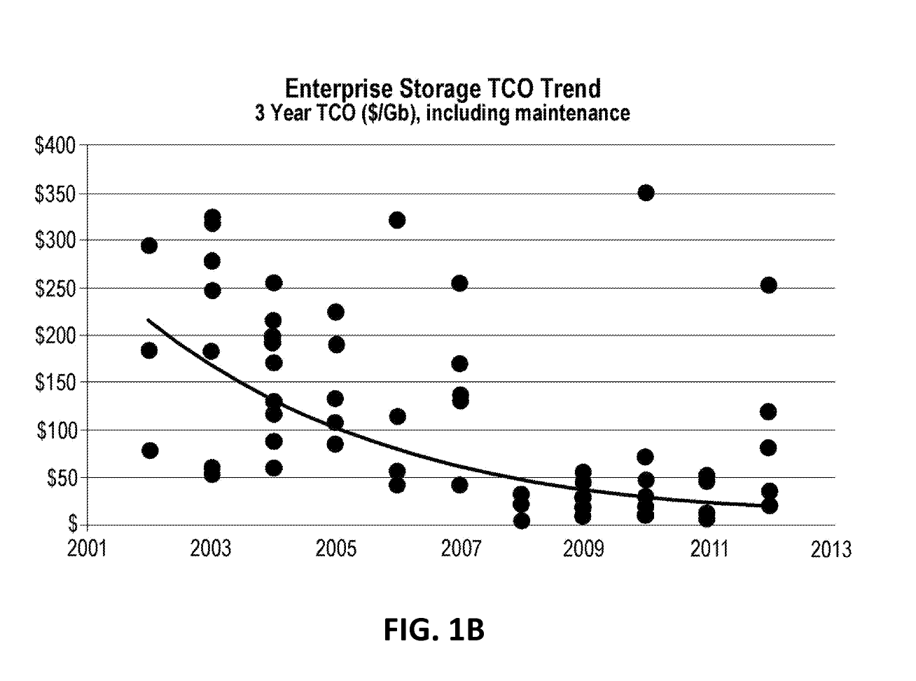

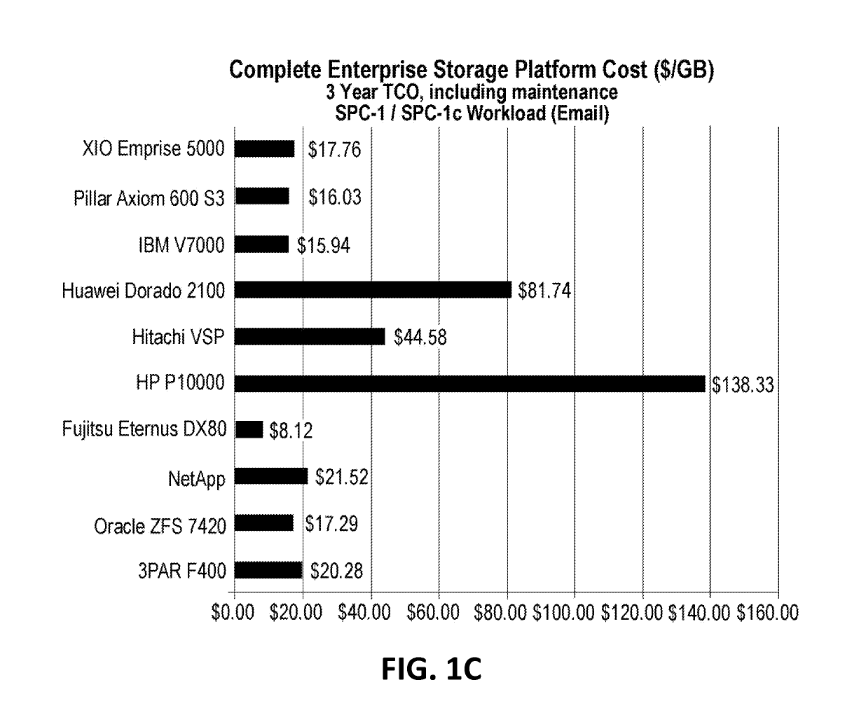

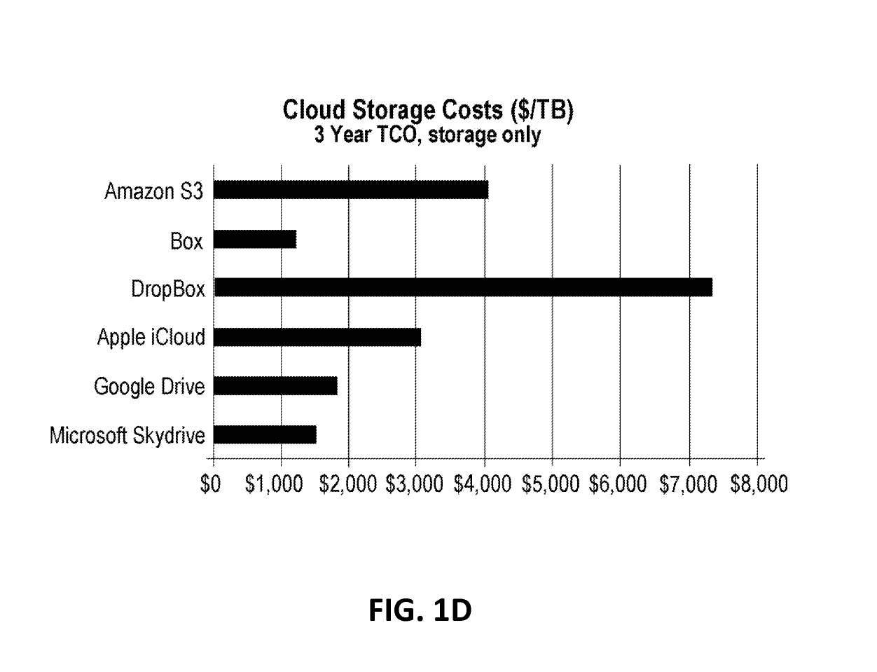

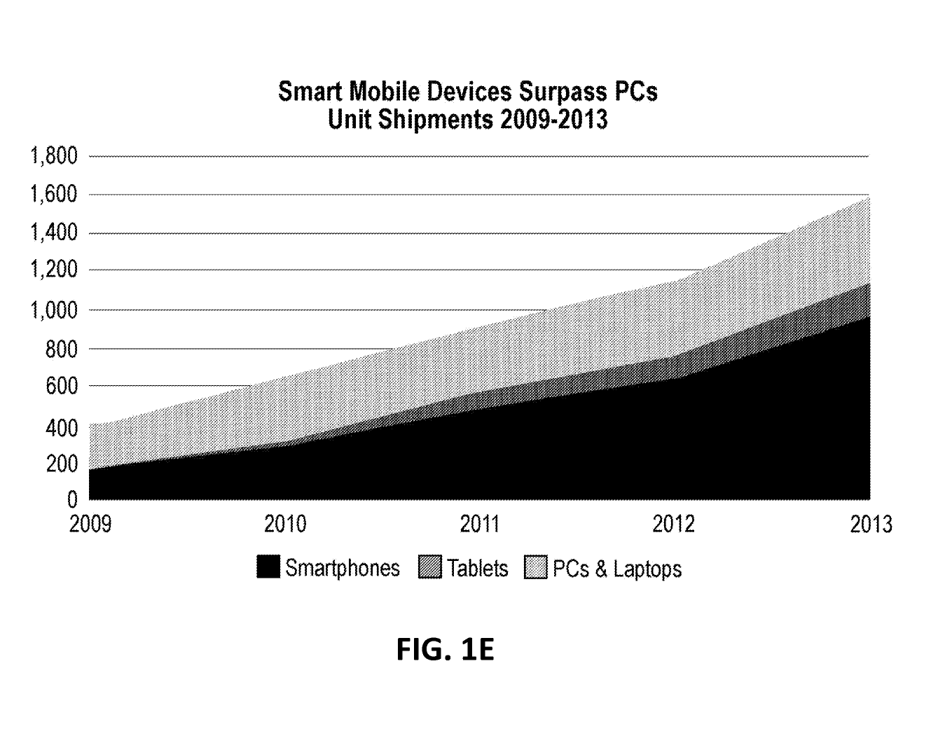

FIG. 1A illustrates exemplary raw storage media costs. More specifically, the raw storage media costs are illustrated in terms of dollars per Gigabyte (GB), from 2009 through 2014 as estimated. As shown, direct costs for storage are declining on a unit basis at rates comparable to Moore's Law, with capacity per dollar doubling every 12-18 months. Enterprise storage media, which features speeds, cache sizes and reliability significantly above that of consumer-grade devices, is now approaching $0.25 per GB of storage, in drive sizes of 500 to 1,500 GB.

While the growth in raw drive capacities and cost per unit of storage gains show little signs of slowing, the costs of high performance I/O, connectivity, availability, management and resiliency remain key factors in the TCO of a storage platform. These capabilities are typically provided within an enterprise storage platform. While media costs have declined by over 60% since 2009 storage platform costs have declined more gradually.

FIG. 1B illustrates exemplary enterprise storage total cost of ownership (TCO) trends, in terms of three year TCO dollars per GB. Today, enterprise storage platforms, with capacities and performance characteristics suitable for large scale messaging platform use, have three year total cost of ownership (including maintenance) in the range of $10-$20 USD per GB of application usable storage.

FIG. 1C illustrates exemplary complete enterprise storage platform costs, in terms of three year TCO dollars per GB. A selection of leading vendor offerings is illustrated, based on standards-based reporting by the Storage Performance Organization (www.storageperformance.org).

FIG. 1D illustrates exemplary cloud storage costs, in terms of three year TCO dollars per GB. Cloud storage alternatives are gaining in popularity, both in the form of consumer services as well as platform as a service (PaaS) offerings such as Amazon S3. The capabilities of these services are quite different from enterprise storage platforms in key areas of connectivity, performance and operational management, and these offerings are not yet feature competitive with leading enterprise storage platforms.

While TCO rates for the base storage appear attractive relative to enterprise storage platforms, transit and I/O charges (or limitations) have dramatic impact on actual costs, while application support and performance are comparatively limited.

FIG. 1E illustrates exemplary smartphone, tablet, and PC and laptop sales. With sales of smart mobile devices now exceeding traditional PCs and laptops, the combination of pervasive mobility, comparatively limited on-device storage, and rich media creation capabilities (HD capable video & photos, plus audio recording) motivate a shift to service-based storage and larger message sizes. Thus, smart mobile devices may drive increased email platform usage.

More specifically, smart mobile devices may impact messaging platforms in at least three ways. For instance, the comparatively limited application storage capacity motivates a preference for service-based storage mechanism, such as provided by IMAP and Exchange ActiveSync. Moreover, the use of multiple devices (desktops, laptops, tablets & smartphones) with a single account, similarly motivates the use of service-based storage mechanism as a way to provide a consistent view across those devices. Further, embedded and easily accessible rich media content creation capabilities, such as HD video, high resolution photographs and audio, all increase the percentage of rich media message, which drive up average message sizes. For email, an obvious consequence of this smart mobile device evolution is a shift towards larger storage quotas and increased message sizes.

Over-the-top services may promote large or unlimited storage capacity. Advertising-funding services, such as Gmail, Hotmail and Yahoo! Mail, remain among the most popular online service offerings, with email being a primary on-ramp service.

These vendors monetize their offerings based on page views, where the value of the advertisement presented is increased by the context and profile information available about the viewer. Increased storage offered to subscribers translates to more visits, which in turn results in increased advertising and cross-sell revenues.

Multi-tenancy in Cloud services may increase subscriber privacy and security concerns. For example, cloud providers may co-mingle data from many customers within one large messaging service, elevating concerns from subscribers about the privacy & protection mechanisms afforded their personal content and information.

Storage challenges may exist for service providers. Fueled by the macro trends discussed in detail above, service providers face an increasing challenge in managing the costs of their storage platforms, which can be summarized in three imperatives: (i) competitive response & advantage, (ii) cost containment, and (iii) capacity planning.

Described herein is a system for storage optimization for messaging platforms that delivers greater storage savings than traditional enterprise platforms, while enabling greater flexibility in capacity planning and integration of cloud storage platforms.

The storage system facilitates intelligent distribution of message storage across multiple locations, each which may have different protocol interfaces and transformations, such as compression, encryption or transcoding. Distribution of messages occurs on both a real-time basis, when a message is received or updated by a client application as well as through scheduled administrative tasks. The immediate benefits of the system may include support for application-enabled compression, integration of cloud storage for flexible expansion, simplified migration and expansion and increased monetization opportunities through account level differentiation.

Application level optimization may have advantages over traditional storage mechanisms. Traditional storage-platform storage optimizations (such as volume compression or hierarchical storage migration) present multiple compromises in user experience and economics, such as: complexities in differentiating quality of service across a subscriber population which shares common data storage demands and patterns; inability to differentiate performance requirements between co-dependent data stored in common volumes or directories; necessarily inefficient compression heuristics based on an absence of application-specific context; and constraints in storage platform options introduced by proprietary solutions.

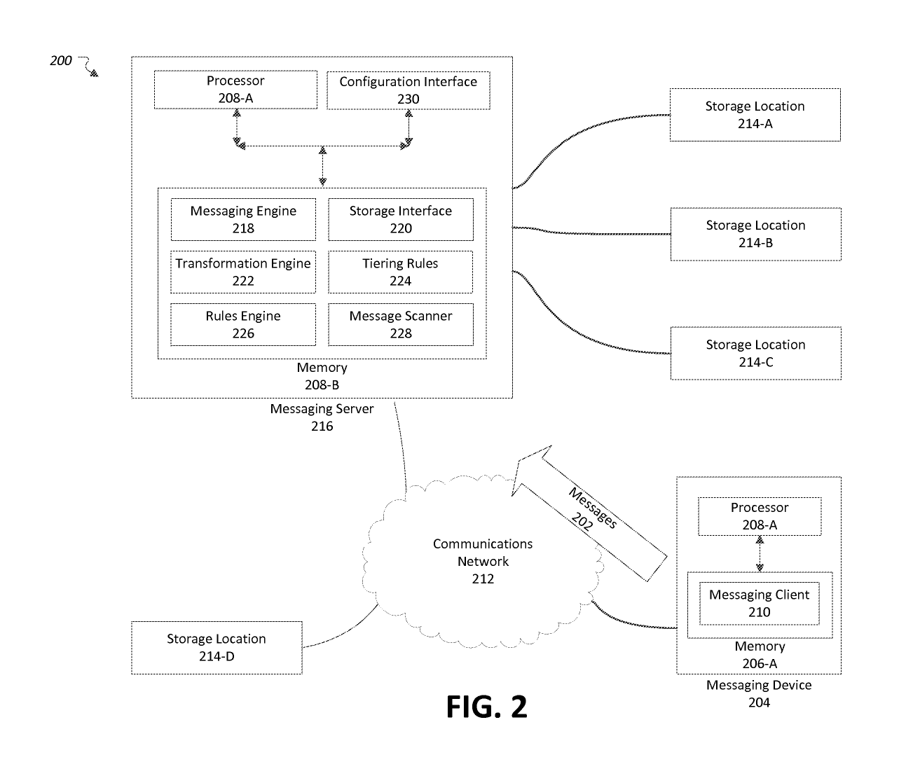

FIG. 2 illustrates an exemplary messaging system 200 for the optimized storage of messages 202 with respect to a plurality of storage locations 214. As shown, the system 200 includes a messaging device 204 having a processor 208-A configured to execute a messaging client 210 stored on a memory 206-A to send the messages 202 over a communications network 212 to a messaging server 216. The messaging server 216 may be configured to receive the messages 202, store the messages 202 in one or more storage locations 214, and deliver the messages 202 to the message recipients. To do so, the messaging server 216 may include a processor 208-B and a memory 206-B storing a messaging engine 218, a storage interface 220, a transformation engine 222, tiering rules 224, a rules engine 226, and a message scanner 228. The messaging server 216 may further provide for configuration of the tiering rules 224 by way of a configuration interface 230. While an exemplary system 200 is shown in FIG. 2, the exemplary components illustrated in FIG. 2 are not intended to be limiting. Indeed, additional or alternative components and/or implementations may be used.

A message 202 may be a communication including information from an originator to be provided to one or more recipients. The message 202 may include information in various formats, such as a plain text format or a hyper-text markup language (HTML) format. The information may also include embedded multimedia content such as graphics, sounds, and video. The message 202 may be addressed to one or more recipient addresses who are to receive the message 202 once it is sent. The message 202 may further include additional data fields, such as a subject field indicative of the contents of the message 202, addresses of the recipients of the message 202, and metadata regarding the message 202 such as information describing the messaging software of the sender and/or routing information. While the messaging systems and methods described herein are illustrated in many examples with respect to e-mail messaging, the concepts disclosed herein are applicable to any other messaging systems and protocols having a potential for message storage, such as instant messaging, short message service (SMS) messaging and multimedia messaging service (MMS) messaging, among other exemplary messaging types.

The messaging device 204 may be a device configured to be operated by one or more users, such as a cellular telephone, laptop computer, tablet computing device, personal digital assistant, or desktop computer workstation, among others. While only one messaging device 204 is illustrated in the system 200, systems 200 may include many messaging devices 204 that may be senders and receivers of messages 202. The messaging device 204 may include one or more components capable of receiving input from a user, and providing output to the user. Messaging devices 204 may be implemented as a combination of hardware and software, and may include one or more software applications or processes stored in memory 206 of the messaging device 204 for causing one or more computer processors 208 of the messaging device 204 to perform the operations of the messaging device 204 described herein.

The messaging client 210 may be one such application included on the messaging device 204, and may be implemented at least in part by instructions stored on one or more non-transitory computer-readable media. Sometimes referred to as a mail user agent (MUA) in examples using email messaging, the messaging client 210 may be configured to allow for the operation and control of the messaging functions of messaging device 204.

The communications network 212 may include one or more interconnected networks that provide communications services, such as Internet access, voice over Internet protocol (VoIP) communication services, SMS messaging services, MMS messaging services, and location services, to at least one connected device. The messaging clients 210, storage locations 214, and messaging server 216 may be examples of such connected devices.

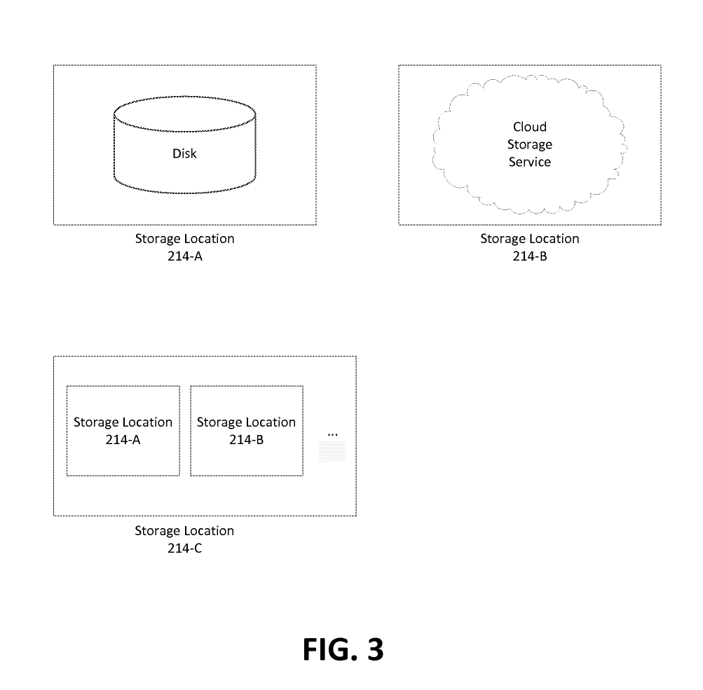

A storage location 214 may include a repository in which a computing device can store and retrieve data. For example, storage locations 214 may be configured to store and retrieve messages 202. Storage locations 214 may be accessed using a variety of methods including, but not limited to, portable operating system interface (POSIX) system calls and network protocols such as the network file system (NFS) distributed file system protocol, the transmission control protocol (TCP) for delivery over Internet protocol (IP networks, or the hypertext transfer protocol (HTTP) application protocol for communication over the world wide web. In some cases, storage locations 214 may be accessed by a computing device over the communications network 212, while in other cases storage locations 214 may be access by the computing device by a connection not requiring routing over the communications network 212. In some cases, storage locations 214 may be collected into storage groups 214, where the storage group 214 may be accessed as if it was a single storage location 214. Further details of the storage locations 214 and storage groups 214 are discussed below with respect to FIG. 3. While the system 200, as illustrated, includes four storage locations 214 (i.e., storage locations 214-A, 214-B, 214-C and 214-D), the system 200 may include more or fewer storage locations 214.

The messaging server 216 may be configured to receive, transmit, store and retrieve messages 202. The messaging server 216 may be implemented as a combination of hardware and software, and may include one or more software applications, modules or processes stored in memory 206 of the messaging server 216 for causing one or more computer processors 208 of the messaging server 216 to perform the operations of the messaging server 216 described herein. The messaging engine 218, storage interface 220, rules engine 226, message scanner 228, transformation engine 222 and configuration interface 230 may be such applications, modules or processes of the messaging server 216, and may be implemented at least in part by instructions stored on one or more non-transitory computer-readable media.

The messaging engine 218 may be configured to aid in the sending and receiving of messages 202 among the messaging devices 204. For example, a sender messaging engine 218, for email messaging sometimes referred to as local mail transfer agent (MTA), may be configured to receive a message 202 from a sending messaging device 204 intending to send the message 202 over the communications network 212. The sender messaging engine 218 may further be configured to review the recipient addresses provided in the message 202, resolve a domain name to determine a fully-qualified domain name of a destination messaging engine 218, and send the message 202 over the communications network 212 to the destination messaging engine 218. The destination messaging engine 218, for email messaging sometimes referred to as a mail delivery agent (MDA) for email messages, may be configured to receive the message 202 from the sender messaging engine 218 and deliver (i.e., store in storage locations 214) the message 202 to the mailboxes of any specified recipients. The destination messaging engine 218 may be configured to utilize post office protocol 3 (POPS) and/or Internet message access protocol (IMAP) to allow for the selective retrieval of messages 202 by messaging devices 204 of the recipients.

The storage interface 220 may be configured provide a common mechanism or interface to facilitate access to one or more homogeneous or heterogeneous storage locations 214. For example, the storage interface 220 may allow other modules of the messaging server 216, such as the messaging engine 218 to communicate with the storage locations 214 without requiring knowledge of the implementation details of the particular storage location 214 or locations 214 being accessed. To do so, the storage interface 220 may maintain configuration information to facilitate access to the storage locations 214. In some examples, each storage location 214 may be associated with a tuple including an access type and messaging protocol for the storage interface 220 to use when communicating with the described storage location 214. thus enabling different types of storage to be integrated in a uniform manner. Examples of such tuples may include access type and messaging protocol information for storage locations 214 as follows: {“file system,” “block based file handler”}, {“cloud storage”, “S3 protocol”}, and {“database”, “JDBC protocol”}. The configuration information may include other information, such as path information identifying the location of the associated storage locations 214 and/or login, password, or other credential information used to gain access to the associated storage locations 214.

The transformation engine 222 may be configured to perform transformations on messages 202. For example, the transformation engine 222 may be configured to replace an entire message 202 or a part of a message 202, such as an attachment, with a different representation of the information being replaced. Exemplary transformations that may be applied by the transformation engine 222 may include, but are not limited to, compression, encryption, encoding, transcoding and de-duplication. Some transformations may be reversible (e.g. lossless compression, encryption) while other transformations may be non-reversible (e.g. lossy transcoding). For reversible transformations, the transformation engine 222 may be configured to perform the transformation as well as the reverse transformation (e.g., message 202 encryption and decryption). In one exemplary configuration, a subscriber may supply a encryption configuration information (e.g., a key or token) for an encrypted message store (e.g., an encrypted mailbox). The transformation engine 222 may be configured to perform the encryption and decryption operations according to the supplied encryption configuration information.

The tiering rules 224 may include a definition of characteristics that may be used to determine how to process messages 202. The criteria that can be utilized for evaluation in a rule 224 encompass attributes of the message 202, of a storage location 214, of a system user and of the system itself. Examples of message 202 attributes may include, but are not limited to: age, size, user folder, flags, tags, last access time, frequency of access measure, message type and, message sub-component type. Examples of storage location 214 attributes may include, but are not limited to: available space, geographic location, performance, type, availability, and cost measure. Examples of user attributes may include, but are not limited to: frequency of use, amount of data stored, class of service (i.e. service plan) and revenue measure. Examples of system attributes may include, but are not limited to: CPU load and available memory.

The tiering rules 224 may include (1) zero or more criteria including indications of matching message 202 characteristics, storage location 214 characteristics, user characteristics and system characteristics that may be used to select (2) zero or more transformations to be applied to the message 202 by the transformation engine 222 the criteria of the tiering rules 224 are met, and (3) one or more storage locations 214 or storage groups 214 into which the message 202 may be stored if the criteria of the tiering rules 224 are met.

As just a few non-limiting examples, the tiering rules 224 may associate storage locations 214 with any one of: a type of message 202, a type of attachment included in the message 202, a characteristic of a subscriber account, history of use of the message 202, a flag included in the message 202, keywords included in the body of the message 202, recipients identified in the message 202, senders identified in the message 202, etc.

It should be noted that it is possible to specify more than one storage location 214 and/or storage group 214 in a tiering rule 224. If the criteria for such a rule 224 are met, the message 202 may be transformed as specified and the output may be stored in all of the defined storage locations 214 indicated by the rule 224 (or in some examples, in a random one of the defined storage locations 214). One use of the specification of multiple storage locations 214 may be data mirroring for high-availability systems or to allow for disaster-recovery redundancy.

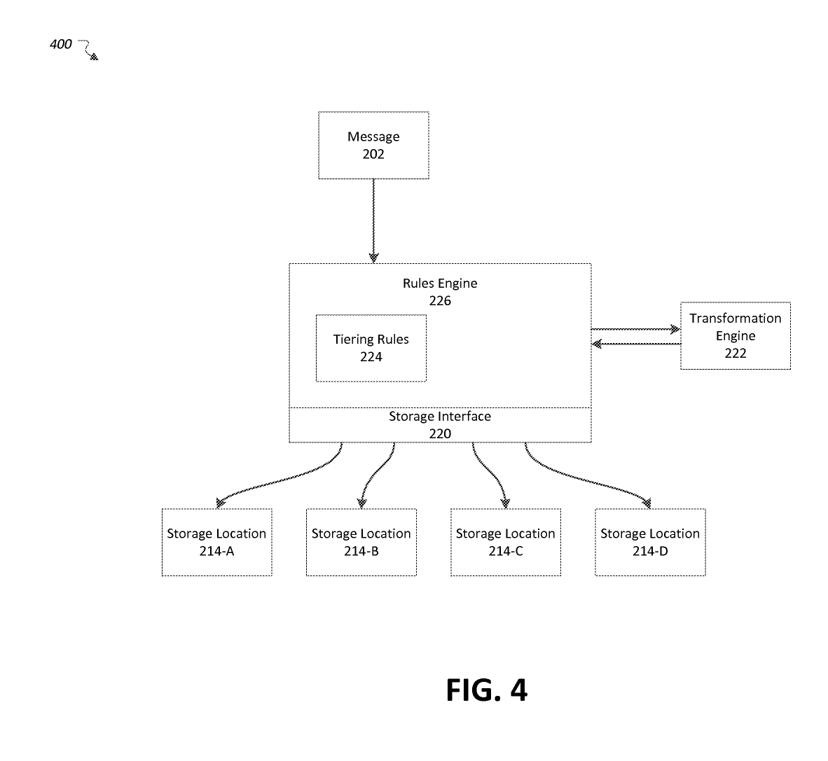

The rules engine 226 may be configured to utilize the tiering rules 224 to determine how to process messages 202. Based on the tiering rules 224 of the system 200, the rules engine 226 may be configured to identify what transformations, if any, to apply to the messages 202, and into which storage location 214 or locations 214 the messages 202 should be stored. The rules engine 226 may be configured to be invoked on a message 202 in the case of an unscheduled event such as a new message 202 being received or by the message scanner 228 for existing messages 202 as discussed below. Further details of the rules engine 226 are discussed below with respect to FIG. 4.

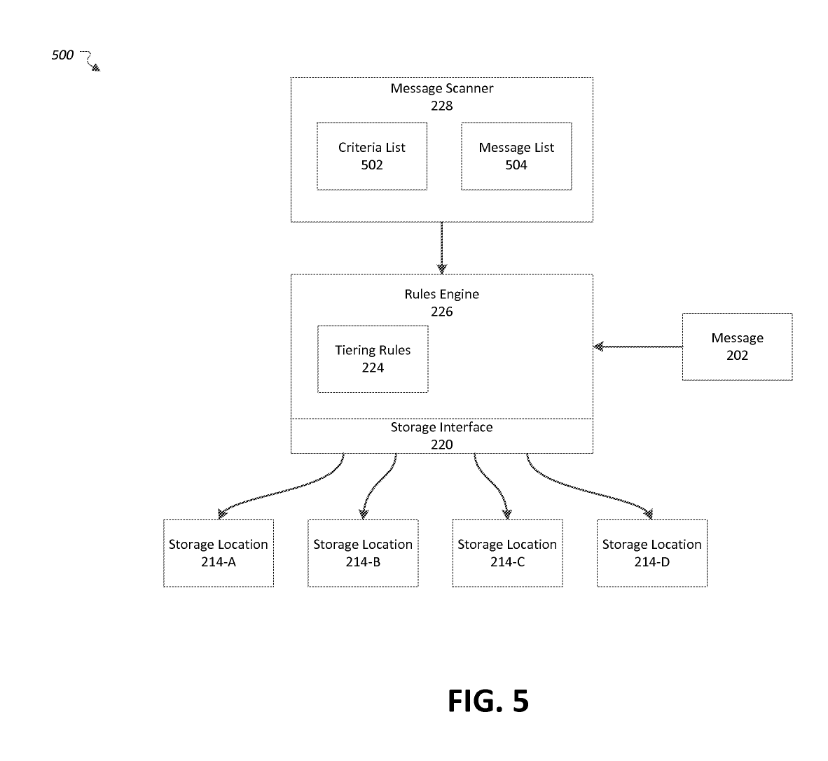

The message scanner 228 may be configured to identify previously stored messages 202 based on search criteria. Thus the message scanner 228 may be used to provide a listing of some or all of the messages 202 of the system 200 to be reevaluated by the rules engine 226 with respect to how and where the messages 202 may be stored. Or, the message scanner 228 may be invoked to locate multiple copies of message 202 for de-duplication. With respect to invocation of the message scanner 228, as one example the message scanner 228 may be configured to be invoked on a scheduled basis (e.g., at midnight on Thursdays, or periodically (e.g., daily, every three days, weekly, monthly, etc.)). As some other examples, the message scanner 228 may be configured to operate based on a change to the tiering rules 224 or based on manual selection. Further details of the message scanner 228 are discussed below with respect to FIG. 5.

The configuration interface 230 may be configured to provide a configuration interface for the messaging server 216. The configuration interface 230 may be utilized to facilitate configuration of various aspects, such as tiering rules 224, storage locations 214, and storage groups 214. For example, the configuration interface 230 may support the management of existing tiering rules 224 (e.g., modification, removal), and the addition of new tiering rules 224. The configuration interface 230 may be further configured to allow configuration of when the tiering rules 224 may be applied. For example, the tiering rules 224 may be applied both based on an event (e.g., message 202 delivery), as well as based on a defined schedule (e.g., invoking the message scanner 228). In some examples, the configuration interface 230 may support a substantially unlimited number of tiering rules 224 that may be defined and applied to messages 202, subject to the resources of the messaging server 216.

The configuration interface 230 may also support the management of tuple or other definitional information with respect to the storage locations 214, including, as some examples: the maintenance of path information to storage locations 214 and encryption configuration information for encrypted storage locations 214 as well as provisioning of nested storage groups 214 including multiple storage locations 214. The configuration interface 230 may be accessible by users with adequate permissions to do so (e.g., administrators of the messaging server 216). One implementation of the configuration interface 230 may be include an application programming interface (API) which allows the system 200 to be managed by an external management framework. Another implementation of the configuration interface 230 may include a command line interface that facilities the scripting of administrative actions. Yet another implementation of the configuration interface 230 may include a graphical user interface that provides a user with an editable view of storage locations 214 and associated tiering rules 224.

FIG. 3 illustrates three exemplary storage locations 214, a disk-based storage location 214-A, a cloud-based storage location 214-B and a group storage location 214-C. While FIG. 3 illustrates three exemplary storage locations 214, one of which may be a storage group 214, the messaging system 200 may include more or fewer storage locations 214 or storage groups 214.

The disk-based storage location 214-A may be a local disk to the messaging server 216, and accessed using a tuple such as {“file system,” “block based file handler”}. The cloud-based storage location 214-B may be accessed over the communications network 212 using a tuple such as {“cloud storage”, “S3 protocol”}, e.g., for an Amazon cloud storage location 214, as well as using other information indicative of an account to use to log into the storage location 214.

Additionally or alternatively, a storage tier 214 may include a nested storage group 214 configured to pool a set of storage locations 214 within the storage tier 214. For example, the storage location 214-C includes two nested storage groups 214, each for storing a plurality of messages 202 with corresponding tiering rules 224. Thus, rather than including a tuple descriptive of the access including an access type and protocol of a message 202, the nested storage location 214-C may be identified according to information indicative of the storage locations 214 included in the storage group 214-C. For instance, the group storage location 214-C may include information identifying the storage location 214-C as including storage location 214-A and storage location 214-B. In some instances, nested storage locations 214 may be referred to as group storage locations 214. Nested storage locations 214 may further be included within other nested storage locations 214, provided multiple levels of storage within a single storage location 214 definition.

Accordingly, if a message 202 is determined by the rules engine 226 to be stored in storage location 214-C, the storage interface 220 may utilize the information identifying the storage location 214-C to determine whether to store the message 202 in one or more of storage location 214-A and storage location 214-B, without requiring further interaction from the rules engine 226. Nested storage groups 214 may be used based on usage patterns within a storage group 214. For example, if one storage location 214 has just been added to a group location 214-C and is empty, storage of messages 202 to that storage device of the storage group 214-C may be preferred over a device of the storage group 214-C that may be more fully utilized. Thus, the storage tier 214-C may be expanded based on an amount of data being stored thereto.

When a tiering rule 224 is applied to a message 202 (i.e., where the tiering rules 224 includes criteria to which the message 202 may match), the message 202 may be placed in an appropriate storage location 214 or storage group 214 specified by the tiering rule 224 (e.g., specified according to group name or other identifier as the proper storage location 214 for messages 202 that match the tiering rule 224). As the matching storage group 214 is filled, the storage group 214 may be expanded with additional storage locations 214 to include more storage locations 214 and capacity within the storage group 214. Accordingly, the messaging system 200 may allow for flexibility in storage capacity by way of the storage groups 214.

In another example, each storage group 214 may include messages 202 with a common characteristic within the messaging system 200. For example, messages 202 may be stored in a storage group 214 based on an association of the message 202 with a basic subscriber account. The messages 202 may then be placed in one of the storage locations 214 in the storage group 214 based on attachment types of the messages 202 (e.g., according to configuration information utilized by the storage interface 220 about the storage location 214). Thus, a two-tiered storage location 214 may be implemented to more efficiently spread the messages 202 across available storage location 214 media (i.e., some portions of the message 202 in one portion of the storage location 214, and other portions of the message 202 in another portion of the storage location 214).

Additionally or alternatively, one or more storage locations 214 may be associated with specific transformations to be applied by the transformation engine 222 to messages 202 stored within the respective storage locations 214. An example of such a transformation would be to compress the message 202 before it is stored in a storage location 214, and decompress the message 202 upon retrieval from the storage location 214. For instance, the information descriptive of the access to the storage location 214-A may specify an encryption algorithm to be performed on messages 202 stored in the storage location 214-A. Other transformations, such as encryption, trans-rating or trans-coding, may also be identified in the information descriptive of the storage locations 214. In some cases, these transformation may be specified by tiering rules 224 configured to store messages 202 in the storage locations 214, while in other cases these transformations may be specified by the configuration information utilized by the storage interface 220 about the storage location 214.

For example, an exemplary system 100 may include four storage locations 214: a storage location 214 named or identified as “spam” and implemented as relatively inexpensive, non-replicated local storage, a storage location 214 identified as “primary” and implemented as a local RAID disc or a SAN, a storage location 214 identified as “tier1” and implemented via NFS, and a storage locations 214 identified as “tier2” and implemented by way of cloud storage. The exemplary system 100 may further include a sequence of rules 224 to allow the rules engine 226 to determine into which storage location 214 a message 202 should be placed. A first rule 224 may indicate that that if a message 202 is contained in a “SPAM” folder, then the message 202 should be stored in the “spam” storage location 214. A second rule 224 in the sequence may indicate that if the message 202 is of a size smaller than two kilobytes and further if the message 202 is younger than two days old, then the message 202 should be stored in the “primary” storage location 214. A third rule 224 in the sequence may indicate that if the message 202 is smaller in size than twenty kilobytes and further if the message 202 is younger than seven days, then the message 202 should be stored in the “tier1” storage location 214. A fourth rule 224 in the sequence may indicate that the message 202 should be stored in the “tier2” storage location 214, thereby indicating the storage location 214 of any messages 202 that fail to match the first three rules 224 in the sequence. An exemplary representation of the aforementioned rules 224 may be specified in the configuration interface 230 as follows:

a. name=spam folder=SPAM

b. name=primary maxsize=2, maxage=2

c. name=tier1 maxsize=20, maxage=7

d. name=tier2

It should be noted that with respect to the second and third rules 224, the default logical operator may be “AND”, indicating that all portions of the rule 224 must match the message 202 for the rule 224 to be selected.

As another example, in addition to the four storage locations 214 mentioned above, the system 100 may further include a fifth storage location 214 identified as “pooledStore” and defined as containing the storage location 214 “tier1” and “tier2”. The exemplary system 100 may further include a sequence of rules 224 including a first rule 224 indicating that that if a message 202 is contained in a “SPAM” folder, then the message 202 should be stored in the “spam” storage location 214, and a second rule 224 indicating that if the message 202 is of a size smaller than two kilobytes and also younger than two days old, then the message 202 should be stored in the “primary” storage location 214. A third rule 224 in the sequence may indicate that the message 202 should be stored in the “pooledStorage” storage location 214, thereby indicating the storage location 214 of any messages 202 that fail to match the first two rules 224 in the sequence may be stored in either of “tier1” or “tier2” storage locations 214. The storage interface 220 may determine which of the “tier1” or “tier2” storage locations 214 to use, for example, based on an identification of a storage location 214 with the most available space, randomly, or based on a non-rule based algorithm such as selection of the next available storage locations 214 using a round robin methodology. An exemplary representation of the aforementioned rules 224 may be specified in the configuration interface 230 as follows:

a name=spam folder=SPAM

b. name=primary maxsize=2, maxage=2

c. name=pooledStore

As a third example, returning to the four storage locations 214 of “spam”, “primary”, “tier1” and “tier2”, a sequence of rules 224 may be implemented using logical operators to specify more complex tiering rules 224. A first rule 224 in the sequence may a first rule 224 indicating that that if a message 202 is contained in a “SPAM” folder, then the message 202 should be stored in the “spam” storage location 214, and a second rule 224 indicating that if the message 202 is of a size smaller than two kilobytes and also younger than two days old, then the message 202 should be stored in the “primary” storage location 214. A third rule 224 in the sequence may indicate that if the message 202 is of a size smaller than twenty kilobytes OR the condition that (i) the message 202 smaller than 200 kilobytes AND (ii) the message 202 is younger than seven days old, then the message 202 should be stored in the “tier1” storage location 224. Notably, this third rule 224 indicates that all messages 202 smaller than twenty kilobytes regardless of age or smaller than 200 kilobytes and less than 7 days old will be stored in the “tier1” storage location 224. A fourth rule 224 in the sequence may indicate that the message 202 should be stored in the “tier2” storage location 214, thereby indicating the storage location 214 of any messages 202 that fail to match the first three rules 224 in the sequence. An exemplary representation of the aforementioned rules 224 may be specified in the configuration interface 230 as follows:

a. name=spam folder=SPAM

b. name=primary maxsize=2 AND maxage=2

c. name=tier1 maxsize=20 OR (maxsize=200 AND maxage=7)

d. name=tier2

More generally, rules 224 may include multiple levels of nesting using precedence operators, and various logical operators, including, but not limited to AND, OR, NOT, and/or combinations of AND, OR, NOT and precedence operators.

FIG. 4 illustrates an exemplary data flow 400 of a rules engine 226 storing received messages 202 in storage locations 214 according to tiering rules 224. The data flow 400 may be performed by systems such as the exemplary system 200 discussed in detail above. As shown in the data flow 400, a rules engine 226 of a messaging server 216 may receive a message 202. Upon receipt of the message 202, the rules engine 226 may identify which of the tiering rules 224 to apply to the received message 202, for example based on attributes of the message 202 or based on attributes of an owner account into which the received message 202 is to be stored. With respect to email messaging as an example, when mailbox operations are processed, specific email messages 202 may be compared with and matched to tiering rules 224 based on attributes of the email message 202. The tiering rules 224 may identify specific characteristics of the message 202 or subscriber account, as well a corresponding storage location 214 into which the message 202 is to be placed if the message 202 matches the criteria specified by the tiering rules 224. In some cases, the tiering rules 224 may further identify specific transformations to be performed on the message 202 before if it stored, if the message 202 matches the criteria specified by the tiering rules 224.

As a more specific example, the tiering rules 224 may specify subscriber account characteristics or class-of-service classifications that may be used to select appropriate storage locations 214 for a message 202. In such an example, a value-aware heuristic may be applied, ensuring that higher value subscribers have their data stored on faster or more available storage locations 214. For example, certain subscribers may be considered premium subscribers and therefore messages 202 within the premium subscriber's messaging account may be saved in high-speed media storage locations 214. Non-premium, or basic, subscribers may utilize a lower-speed media and be saved in a separate storage locations 214 for such. In one such example, all subscriber messages 202 associated with a basic service account may be stored in a relatively less expensive storage location 214, while messages 202 associated with a premium service account may be stored in a relatively more expensive (but faster/more reliable/etc.) storage location 214.

Additionally or alternatively, certain accounts may be associated with specific storage locations 214, as defined by the tiering rules 224. For example, a tiering rule may define that messages 202 owned by users in a particular web domain (e.g., “example.com”) may be stored in a particular storage location 214.

Additionally or alternatively, performance or user experience-aware heuristics may be applied by the tiering rules 224 to ensure that specific application data be stored in a high-speed storage location in order to ensure optimal user experience.

In yet another example, a type-aware characteristic may be defined in a tiering rule 224 and applied to a message 202. For example, rich media files may be stored in storage locations 214 optimized for streaming reads (not high-seek speed media needed for random I/O). As another example of a type-aware characteristic, a tiering rule 224 may specify that computationally-expensive compression not be applied to incompressible file types that may be included in a message 202.

With respect to the matching of rules 224, the rules engine 226 may be configured to match the message 202 to a tiering rule 224 of the plurality of tiering rule 224 specifying multiple storage locations 214 if the criteria of the tiering rule 224 are matched. If so, the rules engine 226 may invoke the storage interface 220 to store a copy of the message 202 in each of the storage locations 214 specified by the tiering rule 224. Or, the rules engine 226 may invoke the storage interface 220 to store a copy of the message 202 in a random one of the specified storage locations 214. The random selection of storage location 214 may be weighted based on properties of the storage locations 214 in the plurality of storage locations 214 including, as some examples, one or more of: available space, speed of performance, throughput, geographical location, type of storage and cost of storage.

As another example, the rules engine 226 may be configured to evaluate the plurality of tiering rules 224 in a sequence order until the criteria in the rule 224 are matched. Upon location of the first match in the sequence, the rules engine 226 may be configured to invoke the storage interface 220 to store the message 202 in the storage location 214 specified by the matching rule 224.

As yet a further example, the rules engine 226 may be configured to evaluate all of the plurality of tiering rules 224 against the message 202, and store the message 202 in a storage location 214 specified by the rule 224 with the best match to the message 202. The rules engine 226 may identify the best match, for example, by assigning scores or weighting to different types of matches or different types of rules 224, and determine the best match as the rule 224 having the highest score. As one example, a rule 224 where all the included criteria match the message 202 may be weighted or scored higher than a rule 224 where only a portion of the criteria of the message 202 match. As another example, a rule 224 including a greater number of criteria or more specific criteria may be weighted or scored higher than a rule 224 having fewer or less specific criteria. As yet a further example, certain criteria such as message 202 size or user folder may be given higher weighting as a match than other criteria such as last accessed time or frequency of access.

In some cases, the rules engine 226 may determine that the message 202 fails to match any of the rules 224. In such a case the rules engine 226 may determine that the message 202 should be stored in a default storage location 214. The default storage location 214 may be determined, for example, based on an identification of a storage location 214 with the most available space, randomly, or based on a non-rule based algorithm such as selection of the next available storage locations 214 using a round robin methodology.

FIG. 5 illustrates an exemplary data flow 500 of a rules engine 226 storing received and scanned messages 202 in storage locations 214 according to tiering rules 224. As with the exemplary data flow 400, the data flow 500 may be performed by systems such as the exemplary system 200 discussed in detail above. Moreover, as shown in the data flow 500, the rules engine 226 of a messaging server 216 may further provide for handling of stored messages 202 identified for later processing by a message scanner 228. Thus, the rules engine 226 may apply tiering rules 224 to both received messages 202 as well as to messages 202 located in a storage location 214.

For instance, the message scanner 228 may be configured to include a criteria list 502 identifying characteristics of stored messages 202 for processing by the rules engine 226. In one example, a message 202 aging function may be implemented using the message scanner 228 to move stale messages 202 (which might be arbitrarily defined as being older than a certain predetermined amount of time, not accessed within a predetermined amount of time, etc.) to lower-cost storage locations 214. To do so, the message scanner 228 may be set to operate periodically using a criteria list 502 including criteria configured to match messages 202 according to the predetermined amount of time (e.g., older than a certain predetermined amount of time). Messages 202 that match the criteria of the criteria list 502 may be included in a message list 504 for reprocessing by the rules engine 226.

Continuing with the timing example, an exemplary tiering rule 224 may be configured to store all messages 202 not accessed for a predetermined time period (e.g., in the last 30 days) in an archive storage location 214. Thus, based on the message list 504 determined by the message scanner 228, the rules engine 226 may identify which of the messages 202 that are at least 30 days old that have also not been accessed for at least 30 days. Those matching messages 202 may accordingly be moved from their current storage location 214 into an archive storage location 214. Thus, by storing messages 202 that have not been recently accessed in an archive storage location 214, a use-sensitive heuristic may be applied, thereby storing less frequently accessed messages 202 on slower and lower cost media, leaving faster and higher cost media for more recently used messages 202.

In some cases, identification of multiple copies of a message 202 may be determined by the messaging engine 218 upon receipt of a message 202 intended for multiple recipients. However, for cases where the duplicate copies of a message 202 arrive or are stored separately, the message scanner 228 may perform additional de-duplication. For instance, the message scanner 228 may be configured to identify multiple copies of a message 202 by scanning one or more storage locations 214 to determine whether another copy of at least a portion of a message 202 (e.g., an attachment to the message 202, the text of the message 202, the entire message 202, etc.) is stored in the same or a different storage location 214. If such a duplicate is found, the message scanner 228 may invoke the storage interface 220 to replace the duplicate copy (or copies) of the message 202 or message 202 part with a reference to the other copy.

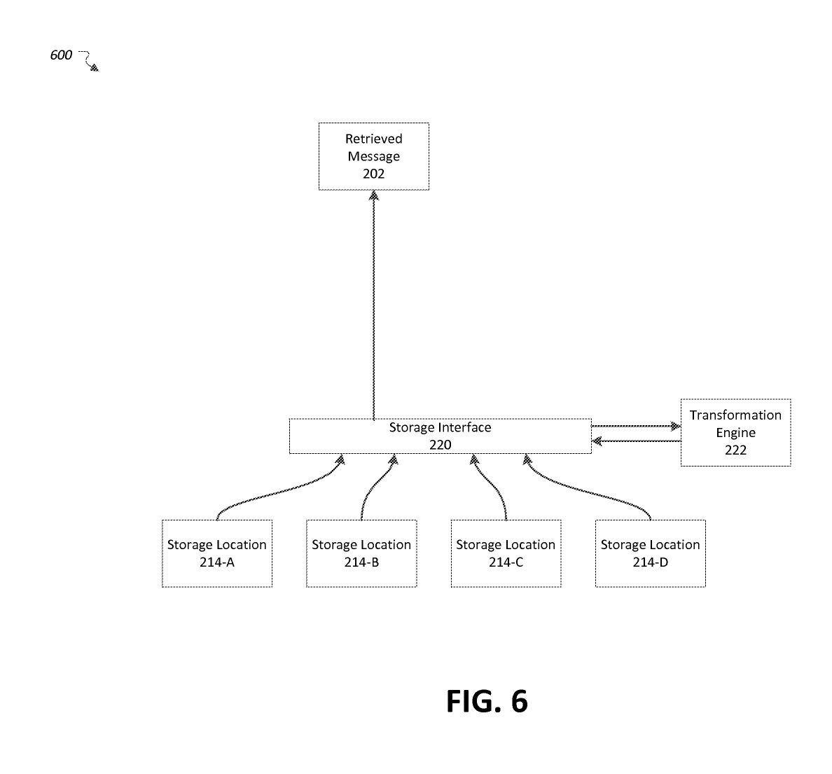

FIG. 6 illustrates an exemplary data flow 600 of a storage interface 220 retrieving stored messages 202. As with the exemplary data flows 400 and 500, the data flow 600 may also be performed by systems such as the exemplary system 200 discussed in detail above. In the data flow 600, the storage interface 220 of the messaging server 216 may receive a request to retrieve a message 202 from storage. For instance, a subscriber may request to view a message 202 sent to the subscriber's account. The storage interface 220 may determine into which storage location 214 the message 202 is currently being stored, retrieve the message from the storage location 214, potentially update the storage location 214 with respect to the last accessed time for the message 202, potentially perform any reverse transformations on the message 202 by way of the transformation engine 222, and may provide the retrieved message 202 to the requester.

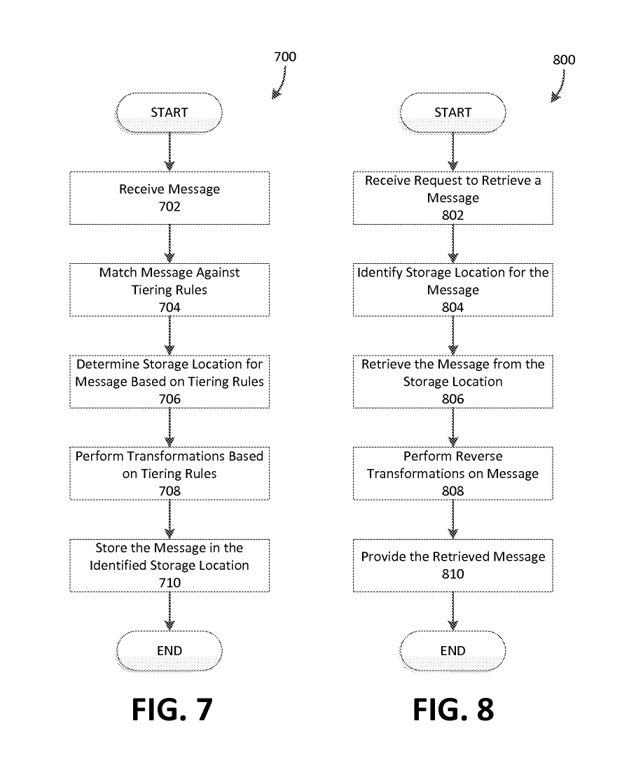

FIG. 7 illustrates an exemplary process 700 for storing received messages 202 in storage locations 214 according to tiering rules 224. The process 700 may be performed by systems such as the exemplary system 200 discussed in detail above.

In block 702, a rules engine 226 of a messaging server 216 receives a message 202 to be processed. For example, the rules engine 226 may receive a new message 202 addressed to a subscriber, or may receive an existing message 202 from storage identified by a message scanner 228 for reprocessing.

In block 704, the rules engine 226 matches the message 202 against tiering rules 224 of the messaging server 216. For example, the tiering rules 224 may include criteria including indications of matching message 202 characteristics, storage location 214 characteristics, user characteristics and system characteristics that may be matched against the message 202.

In block 706, the rules engine 226 identifies into what storage location 214 to place the message 202. For example, based on the tiering rules 224 to which the message 202 was matched, the rules engine 226 may identify from the matched tiering rules 224 one or more storage locations 214 or storage groups 214 into which the message 202 into which to place the message 202.

In block 708, the rules engine 226 performs any transformations required to be made to the message 202. For example, based on the tiering rules 224 to which the message 202 was matched, the rules engine 226 may identify any transformations to be made to the message 202 before it is stored, and may invoke the transformation engine 222 to perform the requested actions.

In block 710, the rules engine 226 stores the message 202 in the identified storage location 214. For example, the rules engine 226 may be configured to invoke the storage interface 220 to place the message 202 into the storage location 214 or locations as indicated by the matching tiering rules 224. The storage interface 220 may accordingly perform the storage using maintained configuration information (e.g., access type and messaging protocol information tuples as discussed above), thereby allowing other modules of the messaging server 216, such as the messaging engine 218 to communicate with the storage locations 214 without requiring knowledge of the implementation details of the particular storage location 214 or locations 214 being accessed. After block 710, the process 700 ends.

FIG. 8 illustrates an exemplary process 800 for retrieving stored messages 202 from storage locations 214. As with the process 700, the process 800 may be performed by systems such as the exemplary system 200 discussed in detail above.

In block 802, a messaging server 216 receives a request to retrieve a message 202 from storage. For example, the request may be sent from a subscriber requesting to view the message 202.

In block 804, the message server 216 identifies a storage location 214 for the message 202. For example, the message server 216 may utilize the tiering rules 224 to determine where the rules engine 226 may have placed the message 202. As another example, the message server 216 may look up the location of the message 202 in a directory indicative of the locations of the messages 202 of the system in the various storage locations 214.

In block 806, the message server 216 retrieves the message 202 from storage. For example, the message server 216 may direct a storage interface 220 of the message server 216 to access the storage location 214 or locations 214 into which the message 202 is stored.

In block 808, the message server 216 performs any reverse transformations to the message 202 that may be required. For example, the storage interface 220 of the message server 216 may direct a transformation engine 222 to perform the reverse transformation (e.g., decryption of an encrypted message 202).

In block 810, the message server 216 provides the retrieved message 202. For example, the message server 216 may return the message 202 to a requester of the message, responsive to the request. After block 810, the process 800 ends.

Accordingly, a rules engine 226 may utilize a tiering rule 224 to determine appropriate storage locations 214 for messages 202. Based on the tiering rules 224, the rules engine 226 may accordingly provide for optimized storage applicable to both content and class-of-service bases. This rules engine 226 may delivers up to a 35% increase in capacity on existing storage volumes, while preserving performance characteristics essential for subscriber experience. The messaging system 200 may support multiple concurrent storage facilities (e.g., storage locations 214), as well as nested storage location 214 groups within the storage locations 214. The messaging system 200 may also provide support for various types of storage locations 214, such as block-based file systems (such as traditional SAN shared volume models), S3-compatible ring or bucket storage, or plug-in support for new standards or vendor proprietary storage APIs. Accordingly, the disclosed messaging system 200 addresses not just today's storage costs, but also enable the use of alternate storage solutions, expand the range of choices for future storage and open the possibility for unique competitive offerings utilizing hybrid or proprietary platforms.

In general, computing systems and/or devices may employ any of a number of computer operating systems, including, but by no means limited to, versions and/or varieties of the Microsoft Windows® operating system, the Unix operating system (e.g., the Solaris® operating system distributed by Oracle Corporation of Redwood Shores, Calif.), the AIX UNIX operating system distributed by International Business Machines of Armonk, N.Y., the Linux operating system, the Mac OS X and iOS operating systems distributed by Apple Inc. of Cupertino, Calif., the BlackBerry OS distributed by Research In Motion of Waterloo, Canada, and the Android operating system developed by the Open Handset Alliance.

Computing devices generally include computer-executable instructions, where the instructions may be executable by one or more computing devices such as those listed above. Computer-executable instructions may be compiled or interpreted from computer programs created using a variety of programming languages and/or technologies, including, without limitation, and either alone or in combination, Java™, C, C++, Visual Basic, Java Script, Perl, etc. In general, a processor or microprocessor receives instructions, e.g., from a memory, a computer-readable medium, etc., and executes these instructions, thereby performing one or more processes, including one or more of the processes described herein. Such instructions and other data may be stored and transmitted using a variety of computer-readable media.

A computer-readable medium (also referred to as a processor-readable medium) includes any non-transitory (e.g., tangible) medium that participates in providing data (e.g., instructions) that may be read by a computer (e.g., by a processor of a computer). Such a medium may take many forms, including, but not limited to, non-volatile media and volatile media. Non-volatile media may include, for example, optical or magnetic disks and other persistent memory. Volatile media may include, for example, dynamic random access memory (DRAM), which typically constitutes a main memory. Such instructions may be transmitted by one or more transmission media, including coaxial cables, copper wire and fiber optics, including the wires that comprise a system bus coupled to a processor of a computer. Common forms of computer-readable media include, for example, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH-EEPROM, any other memory chip or cartridge, or any other medium from which a computer can read.

Databases, data repositories or other data stores described herein may include various kinds of mechanisms for storing, accessing, and retrieving various kinds of data, including a hierarchical database, a set of files in a file system, an application database in a proprietary format, a relational database management system (RDBMS), etc. Each such data store is generally included within a computing device employing a computer operating system such as one of those mentioned above, and are accessed via a network in any one or more of a variety of manners. A file system may be accessible from a computer operating system, and may include files stored in various formats. An RDBMS generally employs the Structured Query Language (SQL) in addition to a language for creating, storing, editing, and executing stored procedures, such as the PL/SQL language mentioned above.

In some examples, system elements may be implemented as computer-readable instructions (e.g., software) on one or more computing devices (e.g., servers, personal computers, etc.), stored on computer readable media associated therewith (e.g., disks, memories, etc.). A computer program product may comprise such instructions stored on computer readable media for carrying out the functions described herein. The rules engine 226 may be one such computer program product. In some example, the rules engine 226 may be provided as software that when executed by the processor provides the operations described herein. Alternatively, the rules engine 226 may be provided as hardware or firmware, or combinations of software, hardware and/or firmware.

With regard to the processes, systems, methods, heuristics, etc. described herein, it should be understood that, although the steps of such processes, etc. have been described as occurring according to a certain ordered sequence, such processes could be practiced with the described steps performed in an order other than the order described herein. It further should be understood that certain steps could be performed simultaneously, that other steps could be added, or that certain steps described herein could be omitted. In other words, the descriptions of processes herein are provided for the purpose of illustrating certain embodiments, and should in no way be construed so as to limit the claimed invention.

Accordingly, it is to be understood that the above description is intended to be illustrative and not restrictive. Many embodiments and applications other than the examples provided would be apparent upon reading the above description. The scope of the invention should be determined, not with reference to the above description, but should instead be determined with reference to the appended claims, along with the full scope of equivalents to which such claims are entitled. It is anticipated and intended that future developments will occur in the technologies discussed herein, and that the disclosed systems and methods will be incorporated into such future embodiments. In sum, it should be understood that the invention is capable of modification and variation.

All terms used in the claims are intended to be given their broadest reasonable constructions and their ordinary meanings as understood by those knowledgeable in the technologies described herein unless an explicit indication to the contrary in made herein. In particular, use of the singular articles such as “a,” “the,” “said,” etc. should be read to recite one or more of the indicated elements unless a claim recites an explicit limitation to the contrary.

What is claimed is:

1. A system, comprising:
a messaging server configured to:
receive a message to be stored by the messaging server,
evaluate, by a rules engine according to a plurality of tiering rules, the message to determine a storage location into which to place the message, each tiering rule specifying criteria to match against the message and at least one storage location into which to place the message upon a match of the message with the criteria, and
provide the message to a storage interface to be stored in the at least one determined storage location.

2. The system of claim 1, wherein each of the tiering rules specifies at least one of: (i) criteria based on attributes of the message, (ii) criteria based on attributes of a storage location, (iii) criteria based on attributes of the computer system; and (iv) criteria based on attributes of the message owner.

3. The system of claim 1, wherein the messaging server is further configured to store the message in a default location if the message fails to match any of the tiering rules.

4. The system of claim 1, wherein the messaging server is further configured to at least one of:
(i) match the message to a tiering rule of the plurality of tiering rules specifying multiple storage locations if the criteria are matched, and store a copy of the message in each of the specified storage locations;
(ii) match the message to a tiering rule of the plurality of tiering rules specifying multiple storage locations if the criteria are matched, and store a copy of the message in a random one of the specified storage locations;
(iii) evaluate the plurality of tiering rules in a sequence order until the criteria in the rule are matched, and store the message in the specified storage location; and
(iv) evaluate all of the plurality of tiering rules against the message, and store the message in a storage location specified by the rule with the best match to the message.

5. The system of claim 4, where the random selection of storage location is weighted based on properties of the storage locations in the group including at least one of: available space, speed of performance, throughput, geographical location, type of storage and cost of storage.

6. The system of claim 4, wherein (i) the criteria based on attributes of the message includes at least one of: newly arrived, age, size, user folder, flags, tags, last access time, frequency of access, type of message and type of message sub-component; (ii) the criteria based on attributes of a storage location includes at least one of: available space, speed of performance, throughput, geographical location, type of storage and cost of storage; (iii) the criteria based on attributes of the computer system includes at least one of: CPU load, system load average, memory used and available memory; and (iv) the criteria based on attributes of the message owner includes at least one of: frequency of use, last access time, volume of data stored, class of service and revenue estimate.

7. The system of claim 1, wherein at least a subset of the plurality of tiering rules specify a transformation to be carried out prior to storing the message if the criteria of the respective tiering rule are met.

8. The system of claim 7, wherein at least one of: (i) the transformation includes at least one of: compression of the message, encryption of the message, and transcoding of the message; and (ii) the tiering rules specify for the transformation to be performed on a subset of the message including an attached file.

9. The system of claim 1, wherein the messaging server is further configured to:
determine whether another copy of at least a portion of the message is stored in the at least one storage location; and
replace the duplicate at least a portion of the message by a reference to the other duplicate copy of the at least a portion of the message.

10. The system of claim 1, wherein the messaging server is further configured to combine test criteria using at least one of a logical operator and a precedence operator.

11. A method, comprising:
receiving a message to be stored by the messaging server,
evaluating, by a rules engine according to a plurality of tiering rules, the message to determine a storage location into which to place the message, each tiering rule specifying criteria to match against the message and at least one storage location into which to place the message upon a match of the message with the criteria, and
providing the message to a storage interface to be stored in the at least one determined storage location.

12. The method of claim 11, wherein each of the tiering rules specifies at least one of: (i) criteria based on attributes of the message, (ii) criteria based on attributes of a storage location, (iii) criteria based on attributes of the computer system; and (iv) criteria based on attributes of the message owner.

13. The method of claim 11, wherein the messaging server is further configured to store the message in a default location if the message fails to match any of the tiering rules.

14. The method of claim 11, further comprising at least one of:
(i) matching the message to a tiering rule of the plurality of tiering rules specifying multiple storage locations if the criteria are matched, and storing a copy of the message in each of the specified storage locations;
(ii) matching the message to a tiering rule of the plurality of tiering rules specifying multiple storage locations if the criteria are matched, and storing a copy of the message in a random one of the specified storage locations;
(iii) evaluating the plurality of tiering rules in a sequence order until the criteria in the rule are matched, and storing the message in the specified storage location; and
(iv) evaluating all of the plurality of tiering rules against the message, and storing the message in a storage location specified by the rule with the best match to the message.

15. The method of claim 14, where the random selection of storage location is weighted based on properties of the storage locations in the group including at least one of: available space, speed of performance, throughput, geographical location, type of storage and cost of storage.

16. The method of claim 14, wherein (i) the criteria based on attributes of the message includes at least one of: newly arrived, age, size, user folder, flags, tags, last access time, frequency of access, type of message and type of message sub-component; (ii) the criteria based on attributes of a storage location includes at least one of: available space, speed of performance, throughput, geographical location, type of storage and cost of storage; (iii) the criteria based on attributes of the computer system includes at least one of: CPU load, system load average, memory used and available memory; and (iv) the criteria based on attributes of the message owner includes at least one of: frequency of use, last access time, volume of data stored, class of service and revenue estimate.

17. The method of claim 11, wherein at least a subset of the plurality of tiering rules specify a transformation to be carried out prior to storing the message if the criteria of the respective tiering rule are met.

18. The method of claim 17, wherein at least one of: (i) the transformation includes at least one of: compression of the message, encryption of the message, and transcoding of the message; and (ii) the tiering rules specify for the transformation to be performed on a subset of the message including an attached file.

19. A non-transitory computer readable medium storing a software program, the software program being executable by a messaging server to provide operations comprising:
receiving a message to be stored by the messaging server,
evaluating, by a rules engine according to a plurality of tiering rules, the message to determine a storage location into which to place the message, each tiering rule specifying criteria to match against the message and at least one storage location into which to place the message upon a match of the message with the criteria, and
providing the message to a storage interface to be stored in the at least one determined storage location.

20. The computer readable medium of claim 19, wherein each of the tiering rules specifies at least one of: (i) criteria based on attributes of the message, (ii) criteria based on attributes of a storage location, (iii) criteria based on attributes of the computer system; and (iv) criteria based on attributes of the message owner.

21. The computer readable medium of claim 19, wherein the messaging server is further configured to store the message in a default location if the message fails to match any of the tiering rules.

22. The computer readable medium of claim 19, further comprising at least one of:
(i) matching the message to a tiering rule of the plurality of tiering rules specifying multiple storage locations if the criteria are matched, and storing a copy of the message in each of the specified storage locations;
(ii) matching the message to a tiering rule of the plurality of tiering rules specifying multiple storage locations if the criteria are matched, and storing a copy of the message in a random one of the specified storage locations;
(iii) evaluating the plurality of tiering rules in a sequence order until the criteria in the rule are matched, and storing the message in the specified storage location; and
(iv) evaluating all of the plurality of tiering rules against the message, and storing the message in a storage location specified by the rule with the best match to the message.

23. The computer readable medium of claim 22, where the random selection of storage location is weighted based on properties of the storage locations in the group including at least one of: available space, speed of performance, throughput, geographical location, type of storage and cost of storage.

24. The computer readable medium of claim 22, wherein (i) the criteria based on attributes of the message includes at least one of: newly arrived, age, size, user folder, flags, tags, last access time, frequency of access, type of message and type of message sub-component; (ii) the criteria based on attributes of a storage location includes at least one of: available space, speed of performance, throughput, geographical location, type of storage and cost of storage; (iii) the criteria based on attributes of the computer system includes at least one of: CPU load, system load average, memory used and available memory; and (iv) the criteria based on attributes of the message owner includes at least one of: frequency of use, last access time, volume of data stored, class of service and revenue estimate.

25. The computer readable medium of claim 19, wherein at least a subset of the plurality of tiering rules specify a transformation to be carried out prior to storing the message if the criteria of the respective tiering rule are met.

26. The computer readable medium of claim 19, wherein at least one of: (i) the transformation includes at least one of: compression of the message, encryption of the message, and transcoding of the message; and (ii) the tiering rules specify for the transformation to be performed on a subset of the message including an attached file.
